(19) United States
(12) Patent Application Publication
(10) Pub. No.: US 2014/0349719 A1
(43) Pub. Date: Nov. 27, 2014

(54) ADJUSTABLE FOLDING SHADE

(71) Applicant: James K. Chun, Bellevue, WA (US)

(72) Inventor: James K. Chun, Bellevue, WA (US)

(21) Appl. No.: 14/288,204

(22) Filed: May 27, 2014

Related U.S. Application Data
(60) Provisional application No. 61/827,316, filed on May 24, 2013.

(51) Int. Cl. H04M 1/02; E06B 9/24

(52) U.S. Cl. CPC H04M 1/026; E06B 9/24; H04M 1/0249
USPC 455/575.1; 160/38

(57) ABSTRACT

A folding shade used with a cell phone or tablet computer to improve visibility of the device's display in bright light environments. The shade includes a top panel, two perpendicular side panels, a top extension panel, and an optional rear edge lip. Disposed between the top panel and the side panels and between the extension panel and rear edge lip are living hinges that enable the shade to be shipped and stored in a flat configuration and selectively folded into a three sided structure positioned. During installation, the top panel extends perpendicularly outward from the device's front surface and aligned with the top panel. The two side panels are unfolded and extend downward perpendicularly aligned with the top panel. The extension panel is positioned over the top horizontal surface and the rear edge lip is extended around the back. Clamping surfaces are then used to hold extension panel against a top horizontal surface.

This utility patent application is based on U.S. provisional patent application (Application No. 61/827,316) filed on May 24, 2013.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

This invention pertains viewing shades and more particularly to viewing shades for portable devices.

2. Description of the Related Art

Cell phones and tablet computers are often used in bright environments that make the displays difficult to see. Users will sometimes cup their hands around the edges of the display to reduce light reflected on the display.

When taking pictures with a cell phone or tablet computer, users will aim the cell phone or tablet computer using the display. Sometimes users must ‘cup’ their hands around the edges of the display in order to reduce glare. After taking the picture and saving it as a digital file, it is often sent with a text message to a recipient which requires the use of both hands.

Sometimes users want to take a take a picture using their cell phones or tablet computers using a stand or tripod to hold the cell phone or tablet computer in a steady, fixed position on a flat surface. A stand or tripod designed for use with a cell phone or tablet computer is shown in U.S. Patent application (application Ser. No. 14/080,150), now incorporated by reference herein. The stand or holder includes a vertically aligned post that attaches to a base and an adjustable clamping head member. Mounted on the head member are two spring-loaded arms that spread apart along the back of the cell phone. Each arm includes a perpendicularly aligned finger or outer plate that extends around the opposite side edges of the cell phone. The post and the head member are relatively narrow so the lens mounted on the back of the cell phone or tablet is unobstructed when placed on the holder.

What is needed is compact, adaptable shade for use with a cell phone or tablet computer. What is needed is a shade that attaches to the cell phone or tablet computer that is held by the user's hand or can be used with a cell phone or tablet computer attached to a stand or tripod position on a fixed surface.

### SUMMARY OF THE INVENTION

A compact, adaptable shade is disclosed for use with a cell phone or tablet computer The shade is designed to be mounted over the display of a standard cell phone or tablet computer when hand held and operated in a normal manner and does not damage or require modification of the cell phone or tablet computer. The shade is also designed to selectively attach over the display of a cell phone or tablet computer mounted on a stand or tripod.

The shade includes a top panel, two perpendicular side panels, a top edge extension panel, and an optional rear edge lip. Disposed between the top panel and the side panels and between the extension panel and rear edge lip are living hinges that enable the shade to be shipped and stored in a flat configuration and selectively folded into a three sided structure that may be positioned over the display. More specifically, when folded in a three sided structure, the extension panel is positioned longitudinally over the top horizontal edge of a cell phone or tablet computer when held or mounted on a stand in a landscape orientation. The top panel, which is straight, extends perpendicularly outward from the device's front surface and substantially aligned with the front edge of the top horizontal surface. The two side panels extend outward from the device's two front lateral edges. The extension panel may include an optional rear edge lip that may be folded downward and extended around the device's rear surface.

In one embodiment, the shade is distributed with a clip that snap fits around the top and bottom surfaces of the cell phone or table computer to hold the shade in place on the cell phone or tablet computer.

In another embodiment, the shade may be used a cell phone or tablet computer with a protective bumper that engages and protects the perimeter edges of the cell phone or tablet computer. The bumper is made of flexible, resilient material that allows the user to twist and bend the bumper over the cell phone or tablet computer. During installation, the extension panel is sufficiently thin and flexible and slides under the top front edge of the bumper placed over the top horizontal surface of the cell phone or tablet computer to hold the shade in place.

In a third embodiment, the shade is used with a cell phone or tablet computer mounted on a stand or tripod mount with at least two clamping arms configured to grasp the top and bottom surfaces of the cell phone or tablet computer. The extension panel is placed under the clamping arm adjacent to the top horizontal surface to hold the shade in place.

### DESCRIPTION OF THE DRAWINGS

FIG. 1 is a top plan view of the adaptable shade positioned on a cell phone attached to a holder.

FIG. 2 is a front elevational view of the shade, the cell phone and the holder shown in FIG. 1.

FIG. 3 is a right side elevational view of the shade, the cell phone and the holder shown in FIG. 1.

FIG. 4 is a top perspective view of the shade used with an optional clip used to attach the shade to a cell phone

FIG. 5 a top plan view of the shade, clip and cell phone in FIG. 4.

FIG. 6 is a rear elevational view of the shade, clip and cell phone shown in FIG. 4.

FIG. 7 is a right side elevational view of the shade, clip and cell phone shown in FIG. 4.

FIG. 8 is a top perspective view of the shade in an assembled configuration.

FIG. 9 a top plan view of the shade shown in FIG. 8.

FIG. 10 is a rear elevational view of the shade shown in FIG. 8.

FIG. 11 is a right side elevational view of the shade shown in FIG. 8.

FIG. 12 is a top plan of the shade in a folded, unassembled configuration.

FIG. 13 is a front elevational view of the shade shown in FIG. 12 showing the left side panel pivoting downward.

FIG. 14 is a right side elevational view of the shade in shown in FIG. 12.

FIG. 15 is a top perspective view of a curved base.

FIG. 16 is a bottom perspective view of the curved base.

FIG. 17 is a top plan view of the curved base.

FIG. 18 is a left side elevational view of a tripod base.

FIG. 19 is a right side elevational view of a tripod base.

FIG. 20 is a top plan view of a tripod base.

FIG. 21 is a top perspective view of a dual arm, spring loaded holder.

FIG. 22 is a front elevational view of the holder.

FIG. 23 is a rear elevational view of the holder.

FIG. 24 is a left side elevational view of the holder.

FIG. 25 is a right side elevational view of the holder.

FIG. 26 is a top plan view of the holder.

FIG. 27 is a bottom plan view of the holder.

FIG. 28 is a front plan view of a cell phone with a flexible, resilient bumper attached to its perimeter edges with the adaptable shade positioned over the front surface of the cell phone and the extension panel is inserted under the top edge of the bumper.

FIG. 29 is a top plan view of the cell phone with the bumper and the shade shown in FIG. 27.

FIG. 30 is a side elevational view of the cell phone with the bumper and the shade shown in FIGS. 27 and 28.

### DESCRIPTION OF THE PREFERRED EMBODIMENT(S)

A compact, adaptable shade 50 is disclosed for use with a cell phone or tablet computer, hereinafter known as a device and generally indicated by reference number 15, to improve visibility of the device's display 26 in bright sun light that easily attaches to the device 5 the outer housing 6. The device 5 an flat rectangular or square outer housing 6 with a top horizontal surface 8 an opposite bottom surface 10, two opposite side surfaces 12, 14, a planar front surface 16 and a rear surface 18. Mounted on the front surface 16 is a display 20.

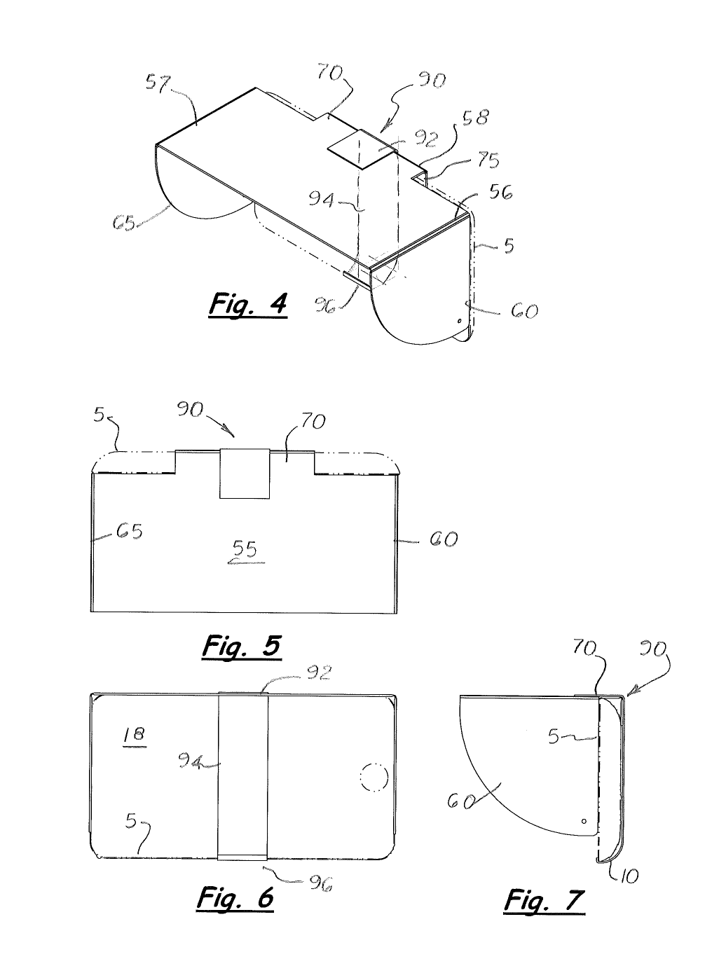

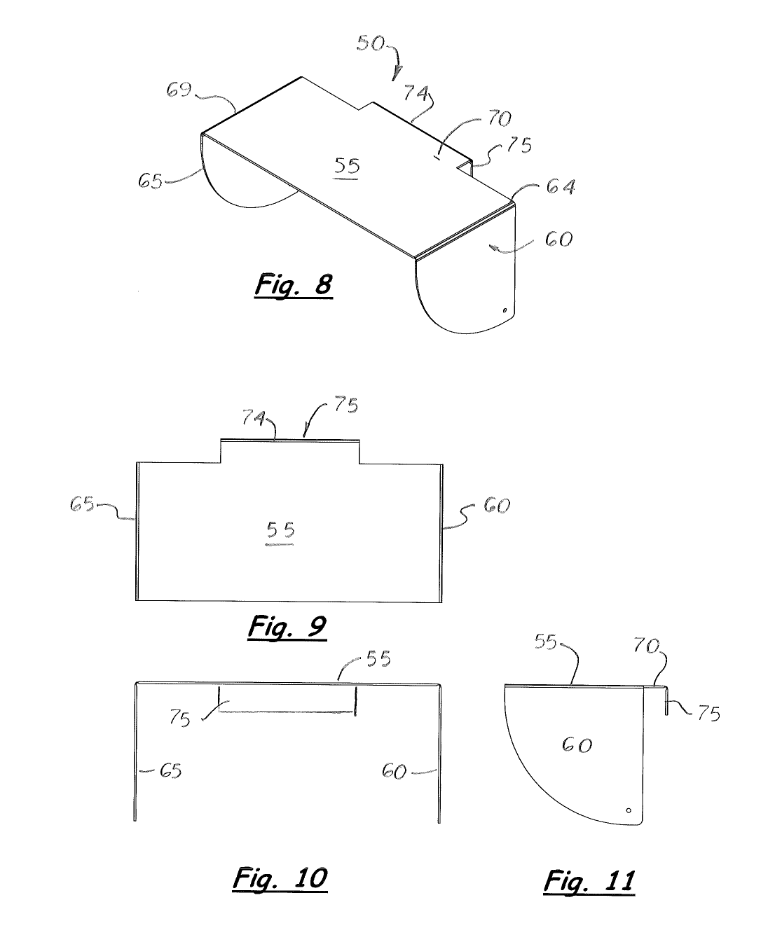

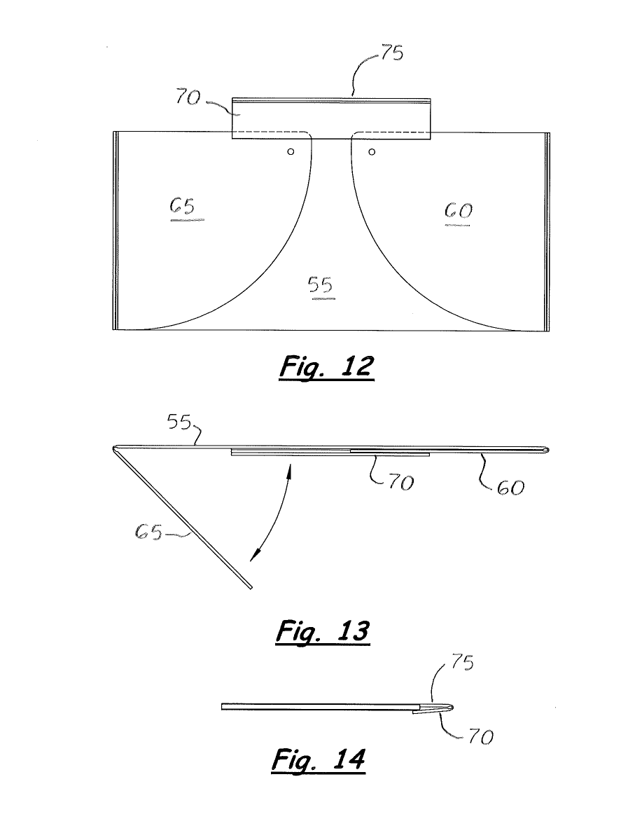

As shown more clearly in FIGS. 2-14, the shade 50 includes a top panel 55 two perpendicular side panels 60, 65, a top edge extension panel 70, and a rear edge lip 75. Disposed between the top panel 55 and the side panels 60, 65 and between the extension panel 70 and an optional rear edge lip 75 are hinges 56. 57. 58, respectively, that enable the shade 50 to be shipped and stored in a flat configuration and selectively folded into a three sided structure positioned longitudinally over the top horizontal surface 14 of the device 5 when positioned in a landscape orientation. After assembly, the front edge of top panel 55 extends perpendicularly outward from the device's front upper edge and the two front edges of the two side panels 60, 65 extend outward from the device's front lateral edges. The extension panel 70 is positioned over the horizontal surface 8 and the rear edge lip 75 is extended around the device's rear surface 18.

The shade 50 is designed to be selectively attached and detached when needed from the device 5. There are three ways to attach the shade 50 to the dev ice 10 without damaging or modifying the device 5.

In one embodiment, the shade 50 is distributed with a clip 90 with an intermediate member 102 with two flexible, opposite clamping arms 102, 104. During use, the intermediate member 10 2 is disposed over the rear surface 18 of the outer housing 6 and the two clamping aims 92, 94 are then disposed over the extension panel 70 placed over the top panel 16 and the bottom surface 18. The device 5 may then be manually carried with the shade 50 attached to the device 5. The clip 100 is made of flexible plastic and configured to snap fit around the top and bottom surfaces 8,10, respectively, of the device 5 to securely hold the shade 50 in place.

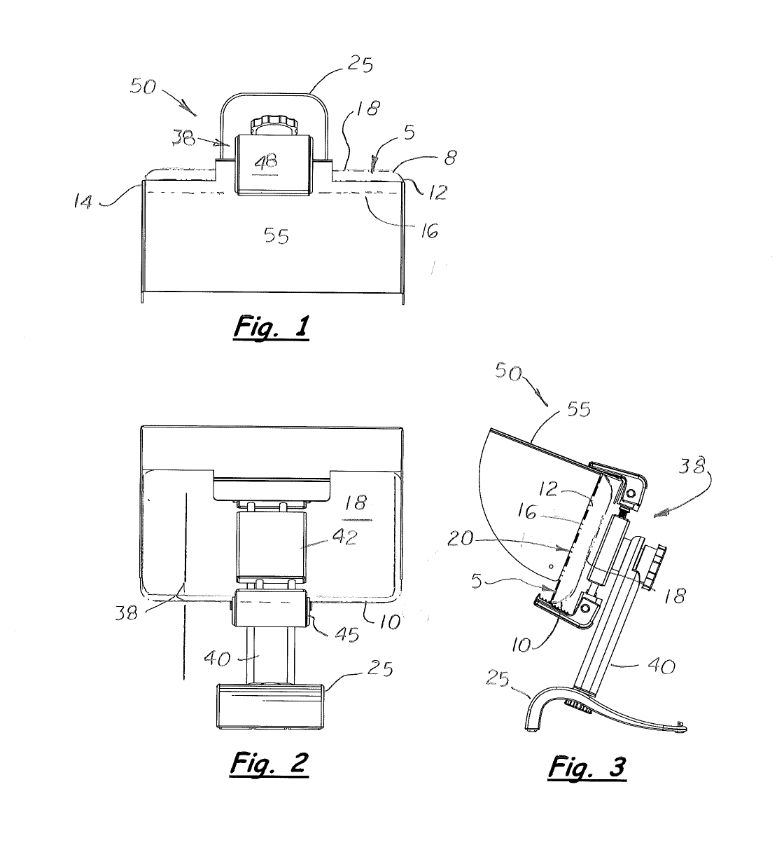

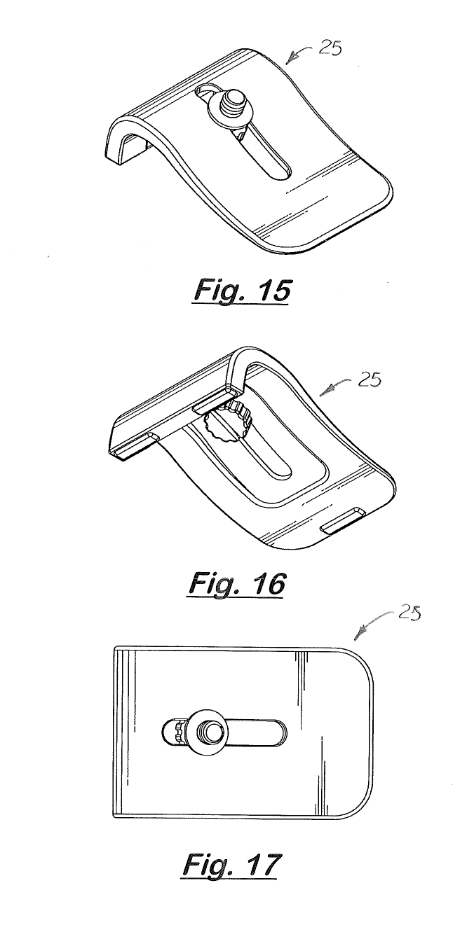

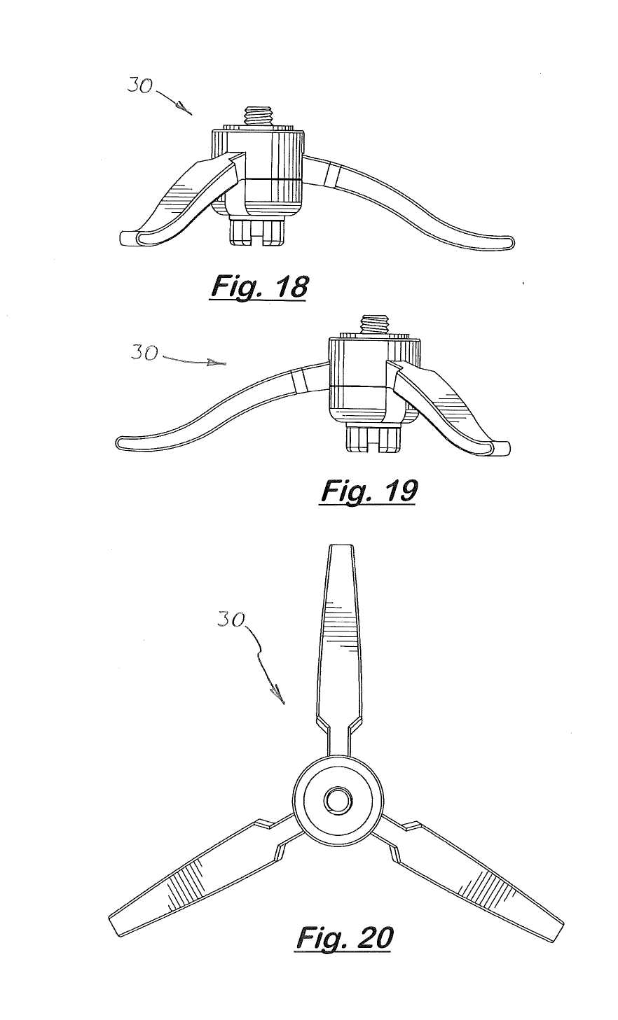

In other embodiments, the shade 50 is designed to be used with other accessories commonly used with a device 5. For example, in FIGS. 1 and 3, the shade 50 is mounted on a two arm clamping member 38 attached a support pole 40. The lower end of the support pole 40 is attached to a S-shaped base 25 with a longitudinally aligned slot 26 and slide bolt 27 that extends upward through the slot 26. (see FIGS. 15-17). The lower end of the support pole 40 is attached to the slide bolt 27. The slide bolt 27 is tighten to hold the support pole 40 in a fixed position. During assembly, shade 50 is mounted on the device 5 the two arms are spread apart so that upper arm on the clamping member 38 extends over the extension panel 70 and the opposite lower arm extends under the bottom surface 10. FIGS. 18-20 show an alternative three legged base 30 that may be used in place of base 25.

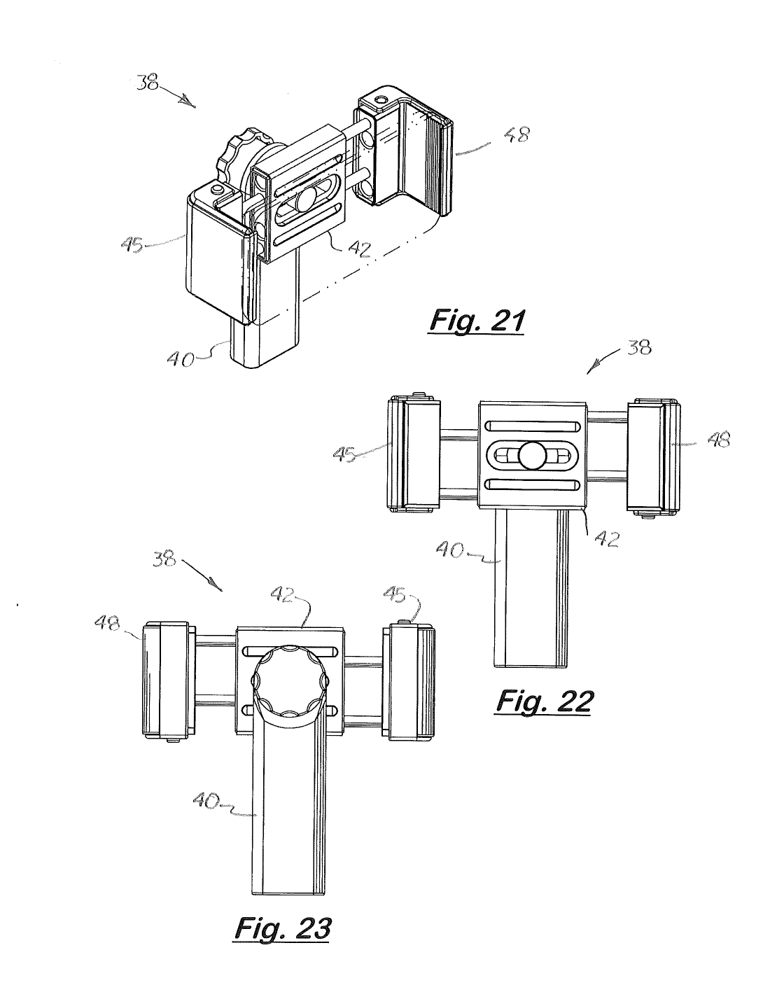

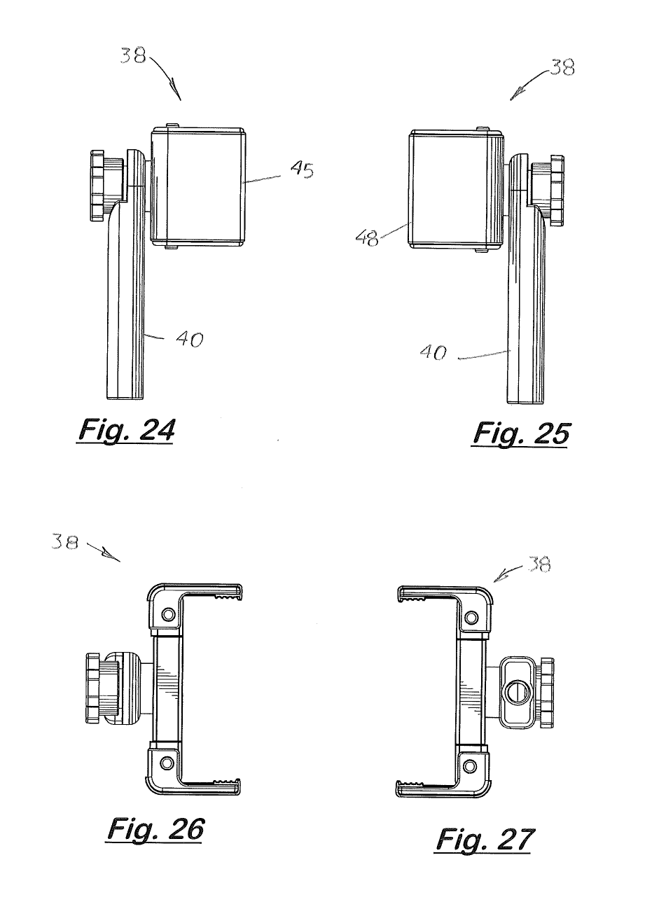

FIGS. 21-27 show different views of the two clamping member 38 attached to a support pole 40. The clamping member 38 includes a center member 42 with two spring loaded clamping arms 45, 48 that slide inward and outward over two slide rods. The center member 42 may rotated 360 degrees over a center post affixed to the upper end of the support pole 40.

When placed in a holder with two clamping arms 45, 48 oriented to grasp the upper and lower edges of a device 5, the extension panel 70 is placed under the upper clamping arm which holds to shade 50 in place over the device.

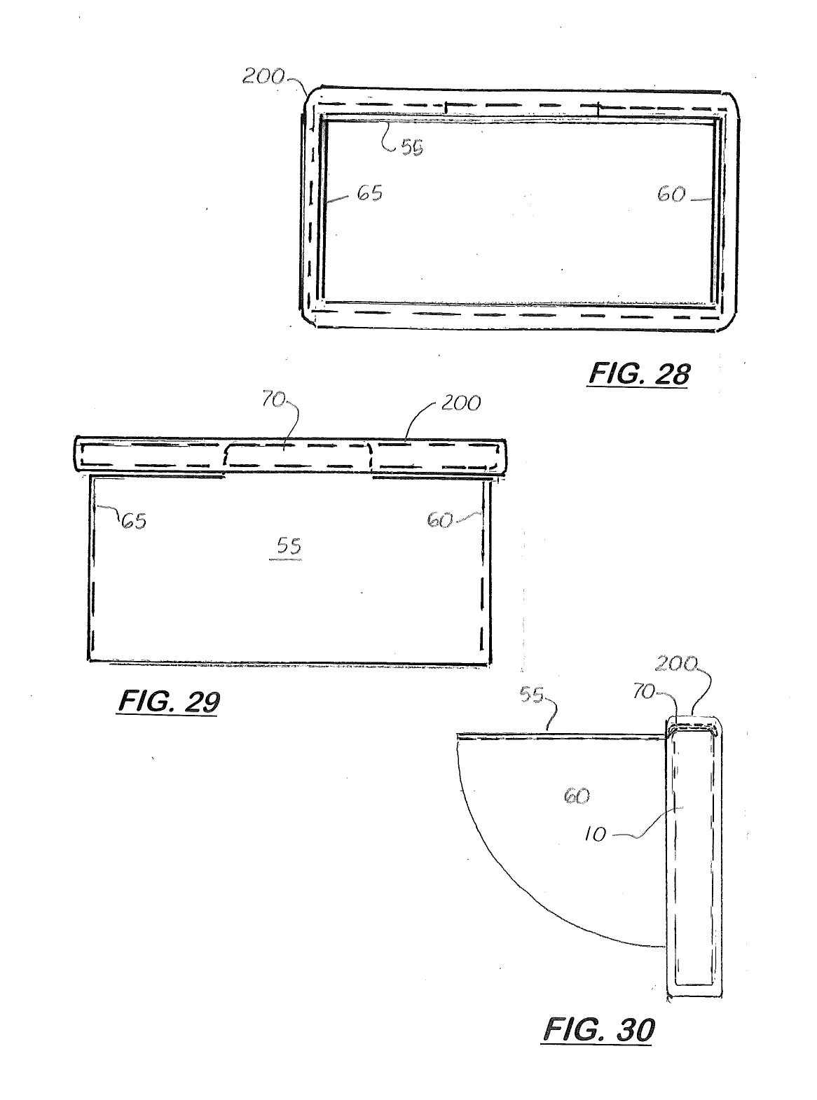

In another embodiment shown in FIGS. 28-30, the device 5 may include a protective case or bumper 200 that engages and protects the perimeter edges of the device 5. The bumper 200 is usually made of flexible, resilient material that allows the user to twist and bend the bumper 200 over the device 5. When the bumper 200 is attached to the device 5, the edge of the bumper is lifted thereby creating a gap in which the extension panel 70 is inserted. The bumper 200 is sufficiently resilient to press against the extension panel 70 and hold the shade 50 in place.

In the preferred embodiment, the shade 50 is made of PVC or stiff paper stock and formed to make a from planar structure with partially perforated hold lines located between the top panel 55 and each side panel 60, 65 and between the extension panel 70 and the edge lip 75. Prior to use, the two side panels 60, 65 are folding 90 degrees from the top panel and the edge lip 75 is fold downward over the device's rear edge.

The top panel 55 measures 5-¼ inches (110 cm) in length×2-½ inches (50 cm) in width. Each side panel 60, 65 measures 2-½ inches (50 cm) in width and 2-½ inches (50 cm) in height. In the embodiment shown, the front edge of each side panel 60, 65 is uniformly curved (radius of 2- 7/16 inches (45 cm)). The extension panel 70 measures 2-½ inches (50 cm) in length and 5/16 inches (10.4 cm) in width. The rear edge 75 measures 2-½ inches (50 cm) in length and ⅛ inch (2.5 cm) in width.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A compact, adaptable folding shade configured for a cell phone or tablet computer with a front display to improve visibility of the display in bright sun light, the shade comprises:
a. a top panel with a length substantially equal to or longer than the front display on a cell phone or tablet computer;
b. two side panels attached to and extending downward below the top panel, said side panels being approximately the same width as said front display on said cell phone or tablet computer; and
c. a top edge extension panel extending rearward from the top panel.

2. The folding shade as recited in claim 1, wherein the top panel, the side panels and the extension panel are made of PVC.

3. The folding shade as recited in claim 1, wherein the top panel, the side panels and the extension panel are made of paper

4. The folding shade as recited in claim 1, further including fold lines disposed between said the side panels and said top panel and a fold line between said extension panel and said top panel enabling said shade to be folded into a flat configuration for shipping or storage and folded into a three sided structure configured to cover the display of a cell phone or tablet computer.

5. The folding shade as recited in claim 1, further including a rear edge lip attached to and perpendicularly aligned to said top edge extension panel.

6. The folding shade as recited in claim 1 further including a clip configured to snap fit around said cell phone.

7. The folding shade as recited in claim 1, further including at least clamping member with at least one clamping arm that extends over the extension panel and holds the extension panel against an adjacent surface on the cell phone or tablet computer.

8. The folding shade as recited in claim 7, wherein said clamping member includes two, spring loaded clamping arms.

9. The folding shade as recited in claim 8, wherein the dual spring arm holder is attached to a vertical support post that attaches to a support base.

10. The folding shade as recited in claim 9, wherein said support base is a s-shaped base with at longitudinally aligned slot with at sliding bolt disposed therein configured to attached to a support post.

11. The folding shade as recited in claim 9, wherein said support base is a three legged base configured to attached to a support post.

12. The folding shade as recited in claim 1, further including a flexible, resilient bumper attached to the perimeter edges of the cell phone or tablet computer surrounding the display, the bumper forms a slot in which the extension panel is placed to hold the shade on the device.

13. A combination of a cell phone and selectively attachable shade, comprising:
a. a cell phone with an outer housing with a top horizontal surface and a front surface with a display mounted thereon, said display having a fixed length and width; and,
b. a folding shade comprising a top panel with a length substantially equal to said top horizontal surface and said display on said outer housing, or longer than said display, said shade including two side panels attached to and extending downward from said top panel, said side panels being approximately the same width as said display, said shade also including top edge extension panel extending rearward over said top horizontal surface;
c. a clamping surface to hold said extension panel over said top horizontal surface; and,
d. wherein said side panels are distributed in a fold configuration under said top panel and then unfolded prior to attachment so that said side panels are substantially perpendicularly aligned position from said top panel, said top panel and said side panels are then positioned over said display so that said extension panel is disposed over said top horizontal surface and said clamping surface is used to hold said extension panel against said top horizontal surface.

14. The combination of a cell phone and selectively attachable shade as recited in claim 13, wherein said clamping surface is a clip that that snap fits around said top horizontal surface on said cell phone or said tablet computer.

15. The combination of a cell phone and selectively attachable shade as recited in claim 13, wherein said clamping surface is a clip that that snap fits around said top horizontal surface configured to hold said extension panel on said top horizontal surface on said cellular telephone.

16. The combination of a cell phone and selectively attachable shade as recited in claim 13, further including a rear edge lip attached to said extension panel.

17. The combination of a cell phone and selectively attachable shade as recited in claim 16, wherein said clamping surface is two spring arms attached to a head member on a tripod configured to hold said extension panel on said top horizontal surface on said cellular telephone.

18. The combination of a cell phone and selectively attachable shade as recited in claim 13, wherein said clamping surface is resilient bumper that fits around said cell phone, said bumper configured to hold said extension panel on said top horizontal surface on said cellular telephone.

19. The combination of a cell phone and selectively attachable shade as recited in claim 13, wherein said clamping surface is two spring arms attached to a head member on a tripod configured to hold said extension panel on said top horizontal surface on said cellular telephone.
